(19) United States
(12) Patent Application Publication
(10) Pub. No.: US 2002/0099565 A1
(43) Pub. Date: Jul. 25, 2002

(54) Order accepting method and apparatus and storage medium

(76) Inventor: Eiichi Kito, Kanagawa (JP)

Correspondence Address: BIRCH STEWART KOLASCH & BIRCH, PO BOX 747, FALLS CHURCH, VA, 22040-0747, US

(21) Appl. No.: 10/051,091

(22) Filed: Jan. 22, 2002

(30) Foreign Application Priority Data
Jan. 22, 2001 (JP) 2001-013695

(51) Int. Cl. G06F 17/60

(52) U.S. Cl. 705/1

(57) ABSTRACT

To place an order of image printing, a menu image is indicated in a display panel for inputting ordering information to specify the order placed for a printing service provided by an associate. The ordering information is determined in response to an input signal according to the menu image. The menu image includes three regions for setting plural items included in the ordering information. The three regions include a printing service selecting region for selecting one of plural printing services different from one another. A common item specifying region specifies an image that is common between the printing services. A conditioning item setting region sets a conditioning item settable according to the selected printing service.

### BACKGROUND OF THE INVENTION

1. Field of the Invention

The present invention relates to an order accepting method and apparatus and storage medium. More particularly, the present invention relates to an order accepting method and apparatus and storage medium in which plural different types of services or products can be ordered in a very simple manner by using an ordering menu image on a display panel.

2. Description Related to the Prior Art

There are photofinishers or printing associates, who produce photographic prints upon receipt of an order from a customer. There are plural types of associates, including such providing a normal type of service, in which photo film is developed, images from the same are printed to photographic paper, and also images taken by an electronic still camera are printed to recording paper. Another type of the associate provides a special type of the service in which a pictorial or symbolic image is printed to a T-shirt, cup or the like.

Recently, the use of the Internet has been widely spread. On-line trades are also used, in which orders of various types of the services are accepted on line through the communication line. For the on-line trade, the associate providing the service has a web site. An ordering menu image for inputting and transmitting order for the service is included as a part of a web page of the web site, makes the ordering menu image publicly open in the web together with information of guiding the service. The web site is constituted by web pages and a server for storing the web page and sending the same to those who accesses the same. In a set of the web pages, pages are combined with one another by use of linking information.

The web site may be administrated by the single associate, but can be administrated by the plural associates, which provide different types of the services. This type of the web site is called a virtual mall, because it resembles a shopping mall constituted by plural shops arranged as a group. A top page of the web pages is presented by the virtual mall, and indicates a list of the services provided by the associates in the virtual mall. When the customer designates and clicks a desired one of the services, the web page is changed over to jump to a page of one of the associates specialized in the selected service.

The virtual mall can be administrated by cooperation of the associates providing the service of the normal type and the associates providing the service of the special type. It is possible for the associates to avoid risks in the business in meeting various desires of the customer. Furthermore, it is advantageous for the customer to place orders of printing in plural different manners even in the single virtual mall. There is no need of directly contacting one of the associates for each of the type of the services, so the access of the customer to the associates can be easy.

The virtual mall can be accessed by using a personal computer possessed by the customer. Also, the virtual mall may be accessed by using an order accepting terminal device installed in a shop. This is disclosed in JP-A 11-102035.

However, according to the prior art, the web page with the ordering menu image opens in a manner particular to the associate providing the selected type of the services in the virtual mall immediately after the selection. If the associates are different, the shape and arrangement of the ordering menu image are different, and require methods of designating and inputting an item. The customer must operate the ordering menu image in different manners according to the selection of the ordering menu image. Furthermore, he or she may request the use of the same images in two or more types of the services. However, much time and labor have been required, because the images must be read and retrieved at plural times for the plural types of the services.

### SUMMARY OF THE INVENTION

In view of the foregoing problems, an object of the present invention is to provide an order accepting method and apparatus and storage medium in which plural different types of services or products can be ordered in a very simple manner by using an ordering menu image on a display panel.

In order to achieve the above and other objects and advantages of this invention, an order accepting method is provided, in which a menu image is indicated in a display panel for inputting ordering information to specify an order placed for a service provided by an associate. The ordering information is determined in response to an input signal according to the menu image. The menu image includes plural regions for setting plural items included in the ordering information, the plural regions including a service selecting region for selecting one of plural services different from one another. A common item specifying region specifies a common item common between the services. A conditioning item setting region sets a conditioning item settable according to the selected service.

Furthermore, an order accepting apparatus includes a display panel for indicating a menu image for inputting ordering information to specify an order placed for a service provided by an associate. An input unit inputs an input signal according to the menu image. A controller determines the ordering information in response to the input signal. The menu image includes plural regions for setting plural items included in the ordering information. The plural regions include a service selecting region for selecting one of plural services different from one another. A common item specifying region specifies a common item common between the services. A conditioning item setting region sets a conditioning item settable according to the selected service.

The plural services are provided by plural associates.

The plural services are printing services for printing an image.

Furthermore, a communication control unit sends the ordering information to, or receives the ordering information from, one of the plural associates through a communication line, the one associate being combined with a selected one of the plural services.

The conditioning item setting region is preset individually between the plural associates.

The conditioning item includes information of a product type of a product according to the service, layout information of the image in the product, and/or information of an amount and/or cost of the product, and wherein the layout information includes information of a size of the product, disposition of the image, and/or a size of the image.

The service selecting region and the conditioning item setting region are arranged horizontally to one another.

The common item specifying region is disposed under at least one of the service selecting region and the conditioning item setting region.

The plural services include a service of developing photo film and printing the image, a reprinting service of the image, a printing service according to a template layout of plural images, an enlarging printing service of the image, a producing service of a booklet of plural images, a printing service of the image to a sheet, and a printing service of the image to an article.

Furthermore, a storage medium stores an order accepting program, the order accepting program executing a step of indicating a menu image in a display panel for inputting ordering information to specify an order placed for a service provided by an associate, and a step of determining the ordering information in response to an input signal according to the menu image. The menu image includes plural regions for setting plural items included in the ordering information. The plural regions include a service selecting region for selecting one of plural services different from one another. A common item specifying region specifies a common item common between the services. A conditioning item setting region sets a conditioning item settable according to the selected service.

Also, an order accepting method is provided, in which a menu image is indicated in a display panel. Ordering information is determined in response to an input signal according to the menu image, wherein the ordering information is adapted for constituting or producing a service or product, and includes designation information of an ordered object, information of a mode, and information of a condition. The menu image includes an object specifying region adapted for determining the designation information of the ordered object, a mode setting region adapted for determining the information of the mode, and a condition setting region adapted for determining the information of the condition.

### BRIEF DESCRIPTION OF THE DRAWINGS

The above objects and advantages of the present invention will become more apparent from the following detailed description when read in connection with the accompanying drawings, in which:

FIG. 1 is a block diagram schematically illustrating a service network of plural printing associates;

FIG. 2 is a block diagram schematically illustrating a printing system installed at one of the printing associates;

FIG. 3 is a block diagram schematically illustrating an order accepting apparatus;

FIG. 4 is an explanatory view illustrating an starting state of a menu image for placing an order;

FIG. 5 is an explanatory view illustrating a menu image at the time of designating multi-image template printing;

FIG. 6 is an explanatory view illustrating a menu image at the time of designating one of preset template layouts;

FIG. 7 is an explanatory view illustrating a menu image at the time of combining the image into a template layout;

FIG. 8 is an explanatory view illustrating a menu image at the time of combining images into all the template layout;

FIG. 9 is an explanatory view illustrating an order checking menu image for the multi-image template printing;

FIG. 10 is an explanatory view illustrating a menu image at the time of designating a cup printing;

FIG. 11 is an explanatory view illustrating a menu image at the time of combining the image into a cup image;

FIG. 12 is an explanatory view illustrating a menu image at the time when an album production is designated;

FIG. 13 is a flow chart illustrating acceptance of the order in the order accepting apparatus;

FIG. 14 is a flow chart illustrating successive acceptance of orders for plural service items; and

FIG. 15 is a block diagram schematically illustrating connection of a personal computer with a service network.

### DETAILED DESCRIPTION OF THE PREFERRED EMBODIMENT(S) OF THE PRESENT INVENTION

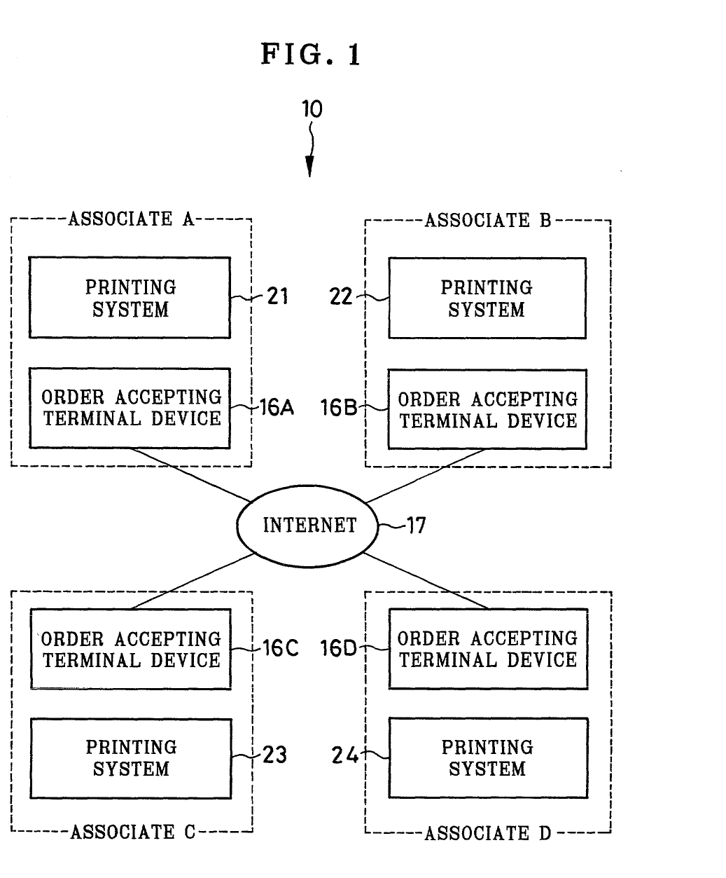

In FIG. 1, a service network 10 of plural printing associates is illustrated. The associates A-D, who administrate the service network 10 in a cooperative manner, are specialized in different printing services. Printing systems 21, 22, 23 and 24 of different types are installed in shops of the associates A-D. Order accepting terminal devices 16A, 16B, 16C and 16D are installed in the shops for accepting orders from customers.

The order accepting terminal devices 16A-16D are interconnected through a network, for example the Internet 17 with a communication line. If a request for the service of a different associate is accepted, the ordering information from the customer is sent to the terminal device of the different associate. In short, the order accepting terminal devices 16A-16D operate as servers for sending and receiving the ordering information. The system of the-service network 10 is constituted by the order accepting terminal devices 16A-16D and the Internet 17.

Therefore, any customer can place an order for printing services of all of the associates A-D even by operating only one of the order accepting terminal devices in the service network 10. Note that data to be transmitted through the Internet 17 are enciphered for the purpose of security as required.

The printing associate A provides normal types of printing services in which images of developed photo film or photographed by an electronic still camera are printed to recording paper or photographic paper. The normal types include the photofinishing (initial printing) service, reprinting service and multi-image template printing service. In the photofinishing (initial printing) service, the original image is subjected to adjustment of image quality and density, before the images are printed. In the reprinting service, images are printed not for the first time but by use of the initially processed image data after the photofinishing. In the multi-image template printing service, the plural images are combined according to predetermined template data. The printing system 21 is constructed for providing the normal types of the printing services.

In contrast, the associates B, C and D are specialized in peculiar types of printing services. The associate B handles the services of printing a pictorial image or photographic image to a cup, T-shirt or the like other than recording paper. The printing system 22 includes a special printer for printing an image to a cup, T-shirt or the like.

The printing associate C is specialized in an album producing service in which plural images are printed to plural sheets, before the sheets are fastened to obtain an album or booklet. The printing system 23 includes an equipment for producing sheets into the album or booklet.

The associate D handles enlargement in which an image is enlarged and printed at a large size such as A2, A3 or the like. The printing system 24 includes a special printer for printing an image in enlargement.

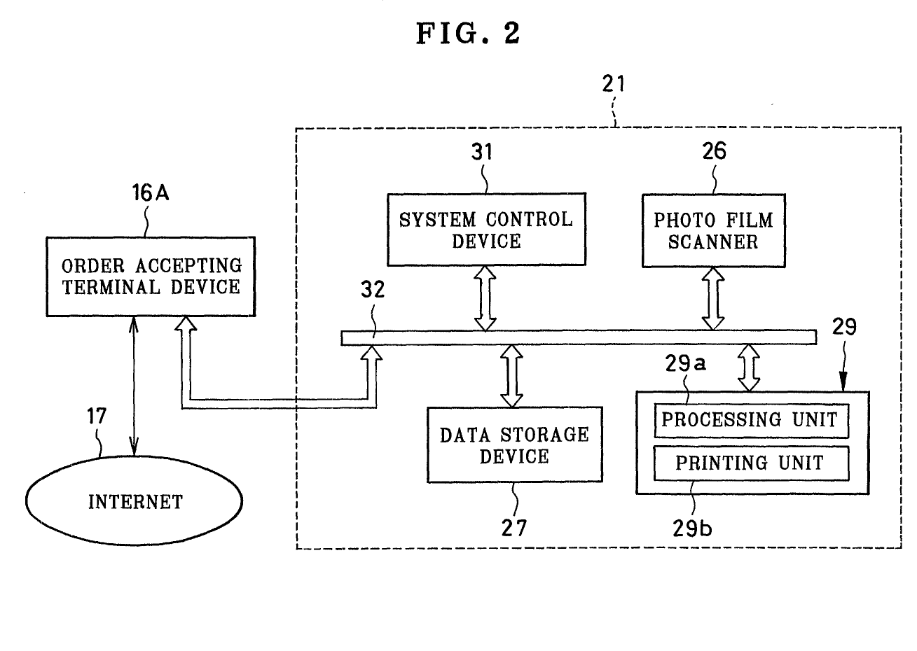

In FIG. 2, the order accepting terminal device 16A and the printing system 21 installed at the associate A are structurally illustrated. The printing system 21 includes a photo film scanner 26, a data storage device 27, a printer 29 and a system control device 31. The photo film scanner 26 reads images from the developed photo film to generate image data by conversion. The data storage device 27 stores template data, image data and the like. The printer 29 prints the images to recording paper. The system control device 31 controls the various elements including those. A data bus 32 interconnects those elements for transmitting data.

The printer 29 includes a processing unit 29a and a printing unit 29b. The processing unit 29a subjects image data to various types of image processing. The printing unit 29b prints an image of the processed image data to recording paper. As an input to the processing unit 29a, image data have been retrieved by the photo film scanner 26, or retrieved from a memory card forwarded from a customer. The types of the image processing include image quality adjusting processing in relation to the contrast, density of respective colors, and the like, image converting processing such as Y-M-C converting processing for converting B, G and R image data to Y, M and C printing image data, and synthesizing processing for combining image data according to a template layout.

The printing unit 29b prints an image to the recording paper according to image data after the image processing. As the printing system 21 is connected with the order accepting terminal device 16A by the data bus 32, printing is effected according to the ordering information generated in the order accepting terminal device 16A by an operator operating the system control device 31.

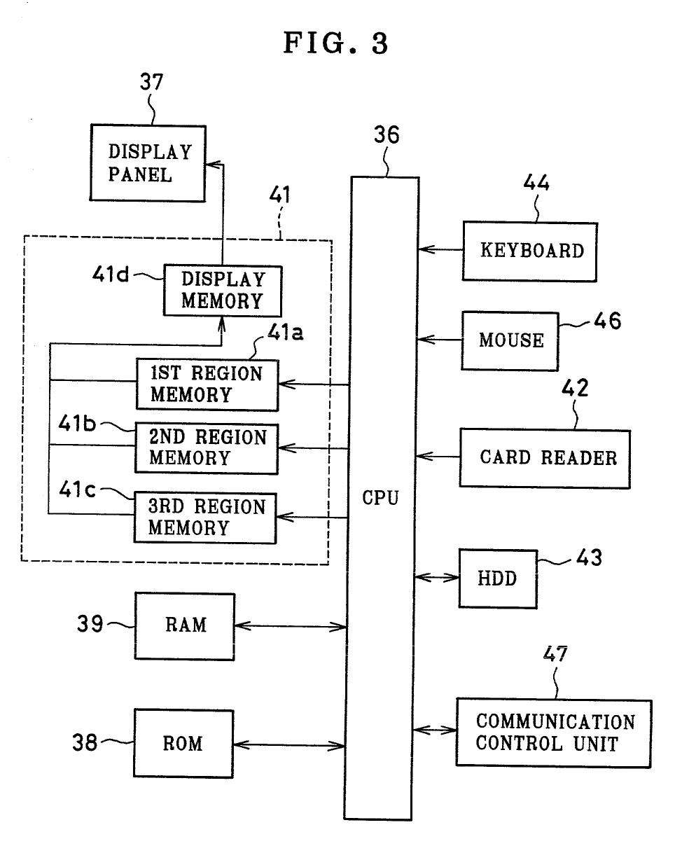

The order accepting terminal devices 16B-16D are structurally the same as the order accepting terminal device 16A. In FIG. 3, the order accepting terminal device 16A includes CPU 36 as a controller, a display panel 37, ROM 38, RAM 39, VRAM 41, a card reader 42, a hard disk drive (HDD) 43 used as a memory, a keyboard 44, a mouse 46, and a communication control unit 47.

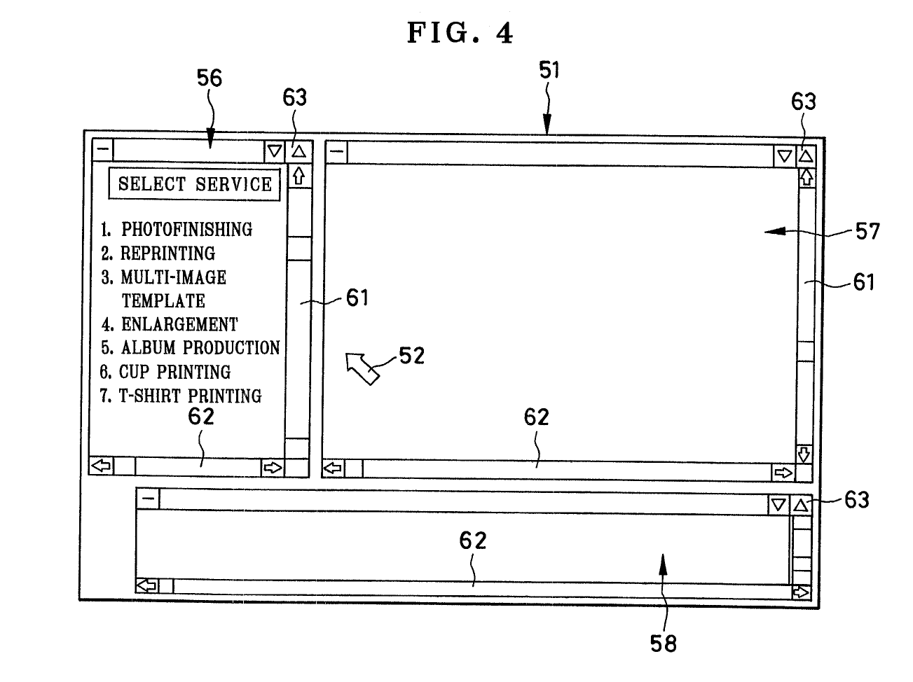

In FIG. 4, an order placing menu image 51 is indicated in the display panel 37 for inputting the ordering information of one service item. According to the menu image, a customer inputs the ordering information by use of the keyboard 44, the mouse 46 and the like as command inputting means. The card reader 42 reads image data written in a memory card known with a trade name of Smart Media. The memory card is brought by the customer, and set in the card reader 42.

The HDD 43 stores the image data read by the card reader 42, and also stores a program for producing ordering information, the ordering information being produced, menu information for being presented in the display panel 37, and the like. The HDD 43 stores information required for the service provided by the associate A. Similarly, the HDD 43 in respectively the order accepting terminal devices 16B-16D stores information required for the particular services provided by the associates B, C and D.

The communication control unit 47 is used for connection with the Internet 17, and sends data to and receives data from the order accepting terminal devices 16B-16D in the service network 10 at the associates B, C and D. In the communication control unit 47, a modem card, LAN card or the like is used to set address information. The communication control unit 47 connects with an address according to the address information, and sends or receives data. The address information is also written to the HDD 43.

ROM 38 stores a program by which CPU 36 processes command signals input by the mouse 46, the keyboard 44 and the like. RAM 39 is a work memory for executing various programs.

VRAM 41 is a specialized memory for indicating a menu image to the display panel 37, and includes a first region memory 41a, a second region memory 41b, a third region memory 41c and a display memory 41d. The menu image, as will be described later, includes three regions different in the purpose. The region memories 41a-41c store information for producing objects to be indicated in the regions. The display memory 41d stores menu image information derived by combining the information written in the region memories 41a-41c. The menu image information in the display memory 41d is output to the display panel 37.

Note that the image simulated in the display panel 37 is used for checking. It is possible to use image data of low definition only for the checking. This enables the speed of display to be high. Furthermore, some type of an image file includes thumbnail indicating image data in addition to main image data. In the case of this type, the thumbnail indicating image data may be used as the image data of low definition. Of course, the main image data may be converted in relation to the definition, to produce image data of low definition. This conversion may be effected by CPU 36, but may be effected by a specified unit for the conversion.

When the order accepting terminal device 16A is started up, at first the display panel 37 is caused to indicate a menu for inputting a customer ID. The time of starting up the order accepting terminal device 16A is for example the beginning time of the business hour of the shop.

A customer at the shop views the ID input menu, and inputs customer ID information that includes a name, address, telephone number, e-mail address and the like. Then the display panel 37 comes to present the order placing menu image 51 of FIG. 4. Note that a system of registration of a customer as a member may be utilized. If the customer has been registered as a member, the customer may be provided with a registration ID number, password and the like. He or she may input the registration ID number or the like in place of the name and address. This can simplify the inputting operation.

The order placing menu image 51 has three regions including a mode setting region or service selecting region 56, a condition setting region or conditioning item setting region 57, and an object specifying region or common item specifying region 58. The order placing menu image 51 is constructed according to GUI (Graphical User Interface) such that buttons are indicated and clicked by using a mouse or the like to input a command signal.

The service selecting region 56 indicates a list of services provided by the associates A-D, and is adapted to selection of one of the plural services. The conditioning item setting region 57 and the common item specifying region 58 are adapted to designation of items of an order according to the selected services. In the conditioning item setting region 57, particular conditions are designated. In the common item specifying region 58, an order is specified irrespective of the plural services.

The menu in the conditioning item setting region 57 can be determined distinctly for each of the service items. The common item specifying region 58 indicates images in a manner irrespective of the service items. A pointer 52 is indicated in the order placing menu image 51, and is moved two-dimensionally in the order placing menu image 51 by using the mouse 46. The pointer 52 is used in a general-purpose manner to designate any of portions in the menu image.

Each of the service selecting region 56, the conditioning item setting region 57 and the common item specifying region 58 is provided with vertical and horizontal scroll bars 61 and 62, a size changing buttons 63 and a closing button 64. The size changing buttons 63 are used for changing the region size. The closing button 64 is used for closing each of the regions.

The scroll bars 61 and 62 are used to scroll each menu image in the service selecting, conditioning item setting, and common item specifying regions 56-58, for a customer to view peripheral portions invisible at one time. Ends of the scroll bars 61 and 62 have arrow buttons. When each arrow button is depressed, the menu image is scrolled in the arrow direction of the depressed arrow button. In each of the scroll bars 61 and 62, a scroll box is provided. When the scroll box is moved, the menu image can be scrolled.

The size changing buttons 63 include maximizing and minimizing buttons. The maximizing button is indicated by a triangle with an upper vertex, and when clicked, makes the one region have a size spread in the whole of the display panel 37. The minimizing button is indicated by a triangle with a lower vertex, and when clicked in the state of the spread size, makes the one region have an initial size.

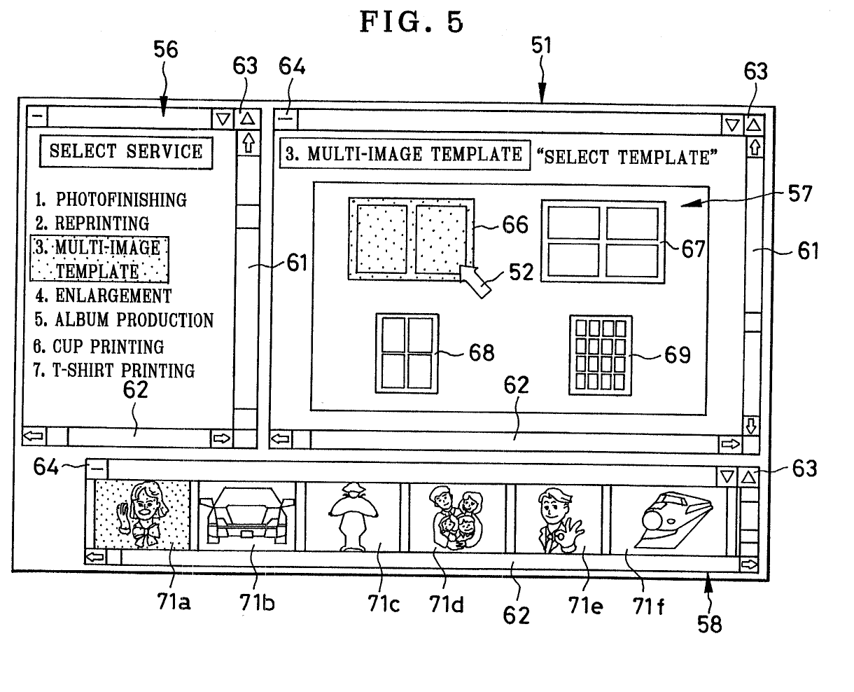

To select one of the services, the pointer 52 is moved and set at the indication of one of the service items. Then the mouse 46 is clicked to execute the selection. If the item “3. MULTI-IMAGE TEMPLATE” is designated as illustrated in FIG. 5, then the color of the item is changed to the light gray. Also, the conditioning item setting region 57 is caused to indicate a menu for designation of condition related to the multi-image template printing service.

The template combining service is provided by the associate A. The menu information for this is determined by the associate A, and stored in the HDD 43. If the template combining service is selected, the menu information is read from the HDD 43.

The conditioning item setting region 57 indicates plural types of template layouts preset in the data storage device 27. In relation to each type, template data includes information of a sheet size, frame size, the number of frames in one sheet, and the like. Thus, the template data makes it easy to combine images. There are a number of types of the template layouts, of which examples include a postcard producing template layout and the like, which will be hereinafter explained.

FIG. 5 illustrates indications of a two-frame template layout 66, a four-frame template layout 67, a portrait template layout 68 and a thumbnail sticker template layout 69. In the two-frame template layout 66, two frames of the C-size (89×127 mm) are disposed in a B5 recording sheet. In the four-frame template layout 67, four frames of a card size are disposed in the B5 recording sheet. The portrait template layout 68 is adapted for the use in an ID document, for example, in an application form for a car license or passport. The thumbnail sticker template layout 69 is used with cutting lines to obtain 16 thumbnail stickers with a portrait, and marketed for example in the trade name of “Print Club”. Also, data of other template layouts are stored in the data storage device 27. The menu image may be scrolled to indicate other template layouts.

A cursor is selectively settable at the template layouts 66-69, of which one pointed by the cursor is rendered distinct from the remainder. In FIG. 5, the cursor points the two-frame template layout 66, which comes to have a distinctly thick line of the contour, and has a grayish color. The cursor is moved by operating the mouse 46 or arrow keys included in the keyboard 44. To confirm the designated template layout, the mouse 46 can be clicked while the cursor is set at the template layout. Alternatively, a return key in the keyboard 44 may be depressed for the confirmation.

An upper portion of the conditioning item setting region 57 is used for indicating a message to encourage a customer or operator, and a message of warning upon occurrence of an invalid operation. When the conditioning item setting region 57 indicates the types of template layouts, a message of “Select a template” is indicated.

Upon selecting the service item, the card reader 42 reads image data from the memory card being set. Frame images 71a-71f are read, and indicated in the common item specifying region 58. The cursor is selectively settable at the frame images 71a-71f, of which one pointed by the cursor is rendered visually distinct from the remainder. To designate an image, the keyboard 44, the mouse 46 or the like is used to move the cursor. The common item specifying region 58 is used for designating an image respective of difference in the printing service items.

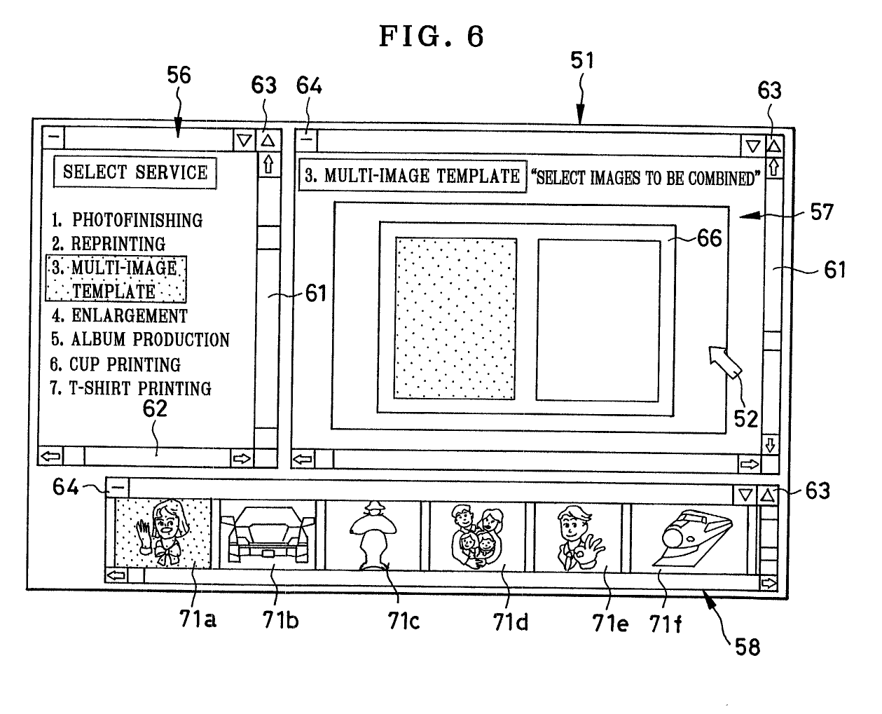

In the conditioning item setting region 57 in FIG. 6, the two-frame template layout 66 is designated. Then the menu is changed over to indicate the two-frame template layout 66 in an enlarged manner. The cursor is settable to any one of the plural frames in the two-frame template layout 66. When the cursor points one particular frame, the frame becomes visually distinct from the remaining frames. In the same menu, the upper space over the two-frame template layout 66 indicates a message of “Select images to be combined”. According to this, one image is designated from those in the common item specifying region 58.

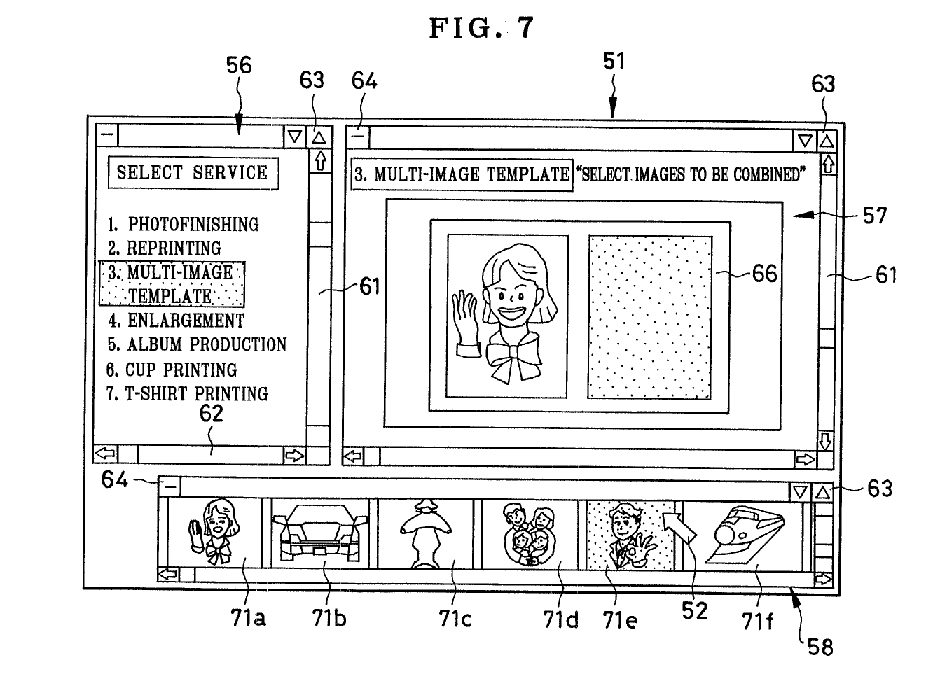

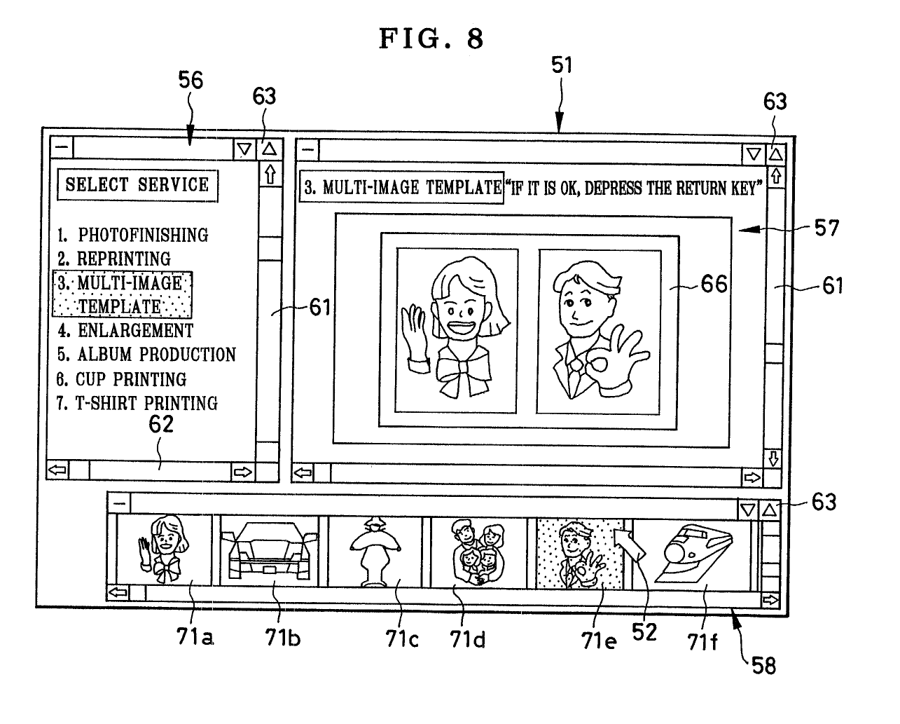

When the frame image 71a is clicked by use of the mouse 46, then the frame image 71a is combined with and inserted in a first space inside the two-frame template layout 66. See FIG. 7. After this, then the cursor moves to a second space inside the two-frame template layout 66. Another frame image, for example, the frame image 71e is designated. Then the frame image 71e is inserted in the second space inside the two-frame template layout 66. See FIG. 8.

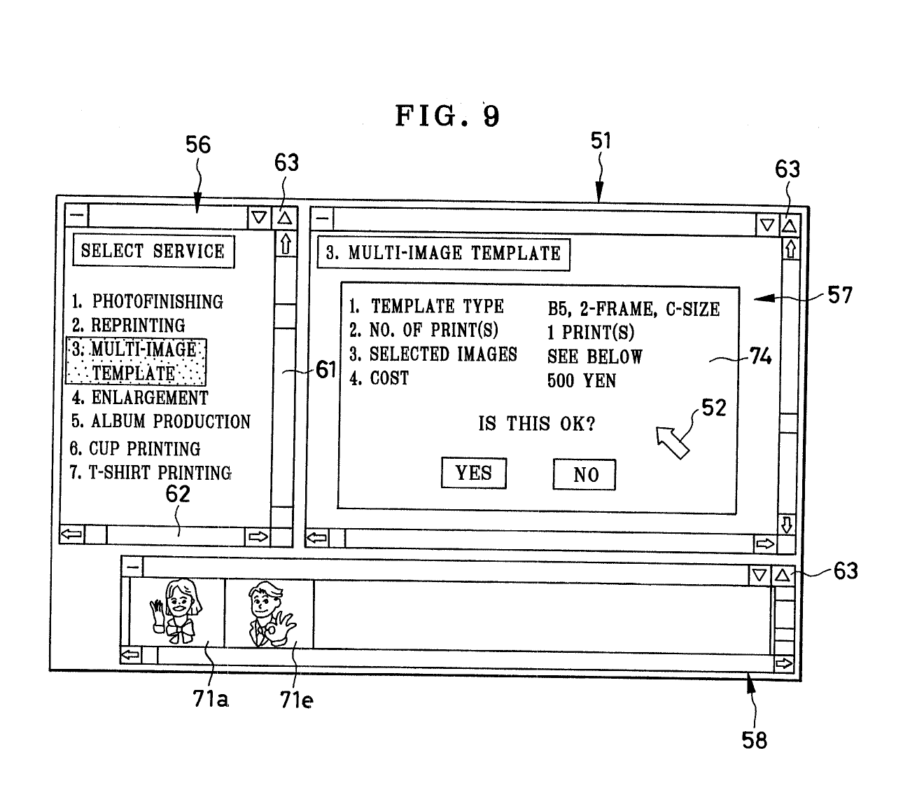

The upper space over the synthesized image indicates a message of “If it is OK, depress the return key”. Upon depressing the return key, the menu is changed over to such for inputting the number of prints. Upon inputting the number, the ordering information is confirmed. In FIG. 9, an order checking menu image 74 is indicated as checking information or amount/fee information. The order checking menu image 74 presents the template type, the number of the prints, selected images, and a cost. A space beside the words of “selected image” indicates “See Below”. The common item specifying region 58 indicates only the frame images 71a and 71e designated for the synthesis.

A lower portion of the order checking menu image 74 indicates a message “IS THIS OK?” and buttons of YES and NO. When the NO button is clicked, the order checking menu image 74 is changed over to a starting menu, to restart selection of the services.

When “YES” is clicked, the ordering information is confirmed, to produce an ordering information file. The ordering information file includes the customer ID information, and includes information of a template number, the number of prints and the number of designated image file. Upon creating the ordering information file, data of images associated with the file are copied from the memory card to the HDD 43. The ordering information file is written to the HDD 43 together with the image data. Thus, the acceptance of the order is completed. At this time, the display panel 37 indicates an expected date and time of accomplishment of prints being ordered, or indicates messages such as “Thank you. We await other orders from you for prints.”

Upon acceptance at the order accepting terminal device 16A, a monitor panel of the system control device 31 is caused to indicate a message of receipt of an order. Then an operator at the associate A operates the system for printing according to the ordering information file. Note that he or she can produce prints as soon as possible, but may do it at one time at an end of the business hour of one day. Also, the printing system can be so programmed that printing starts automatically when the number of orders has come up to a predetermined value.

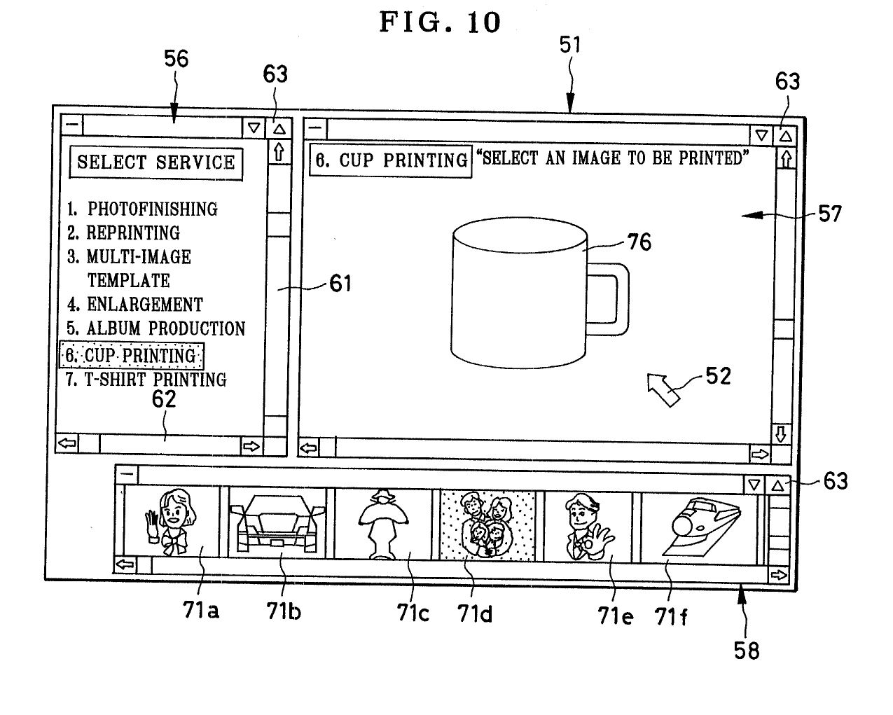

In FIG. 10, the service item “6. CUP PRINTING” is selected next. The conditioning item setting region 57 presents a menu according to the service item. The cup printing is not included in the services provided by the associate A. The menu image information is determined by the associate B specialized in the service item. The menu image information is previously written in the HDD 43 in the order accepting terminal device 16B installed at a shop of the associate B. The order accepting terminal device 16A at the associate A reads the menu image information from the order accepting terminal device 16B through the Internet 17. The information is indicated in the conditioning item setting region 57.

In the order accepting terminal device 16B, images of a plurality of types of cups are stored in the order accepting terminal device 16B. In a menu of “6. CUP PRINTING”, the plural cups are indicated (not shown). A single one of them is designated. In FIG. 10, a cup image 76 becomes enlarged. The common item specifying region 58 is caused to indicate images stored in the memory card in a manner similar to the operation after selection of “3. MULTI-IMAGE TEMPLATE”.

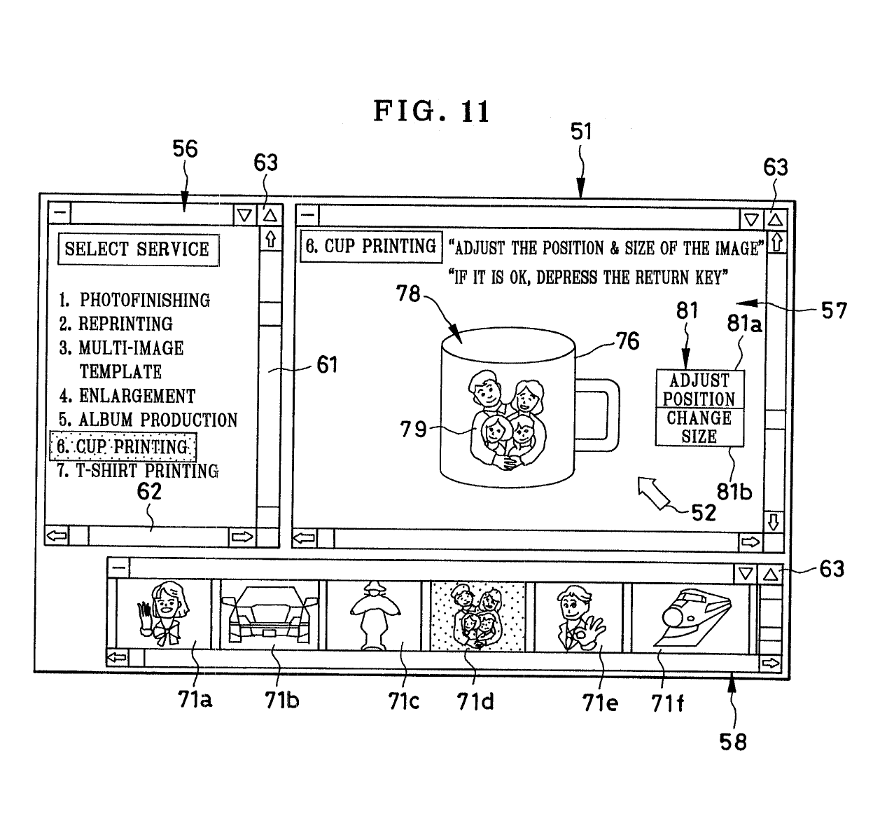

In FIG. 11, the frame image 71d is designated among the plural images. Then a synthesized image 78, which constitutes designation information or layout information, is indicated in the conditioning item setting region 57 and is constituted by the cup image 76 and the frame image 71d. After this, operation of selecting images in the conditioning item setting region 57 is similar to that after designation of the service item “3. MULTI-IMAGE TEMPLATE”.

A layout input box 81 for layout information is indicated in the conditioning item setting region 57 together with the synthesized image 78. The layout input box 81 includes a position adjusting button 81a and a size changing button 81b. An upper portion of the conditioning item setting region 57 higher than the synthesized image 78 indicates messages such as “Adjust the position & size of the image” and “If it is OK, depress the return key”.

If a customer wishes to adjust the printing position of the image, the position adjusting button 81a is clicked. A frame image 79 comes to have a distinctly thick line of the contour inside the cup image 76. Then the pointer 52 is positioned at the frame image 79 and dragged by using the mouse 46. Then the frame image 79 is moved. If a customer wishes to change the printing size of the image, the size changing button 81b is clicked. The frame image 79 becomes surrounded in a distinctly thick line of the contour. Then the pointer 52 is positioned at the thick contour of the frame image 79 and dragged by using the mouse 46. Then the size of the frame image 79 is enlarged or reduced. Information of the printing position and size is written to the ordering information file.

When the desired position and size are obtained, the return key is depressed. The order checking menu is indicated. If the conditions are found acceptable, the return key is depressed again to confirm the ordering information. Then ordering information file is produced inclusive of the customer ID information, printing position, printing size, image numbers of designated images, and the like.

The ordering information file is sent to the order accepting terminal device 16B through the Internet 17 together with the data of designated images. The order accepting terminal device 16B receives the ordering information and image data. If no problem is found, then a message is sent to the order accepting terminal device 16A at the associate A to inform completion of the acceptance. The order accepting terminal device 16A indicates the completion message in the display panel 37. The completion message is constituted by an expected date and time of accomplishment of prints being ordered, or phrases such as “Thank you”.

After the transmission to the order accepting terminal device 16B, the ordering information file and the completion message of the acceptance being received are also stored in the order accepting terminal device 16A. The data will be used later for payment or settlement between the associates A and B.

Operation after designation of the service item “5. ALBUM PRODUCTION” is now described. The menu image information is read from the order accepting terminal device 16C at the associate C, to present a menu image in the conditioning item setting region 57.

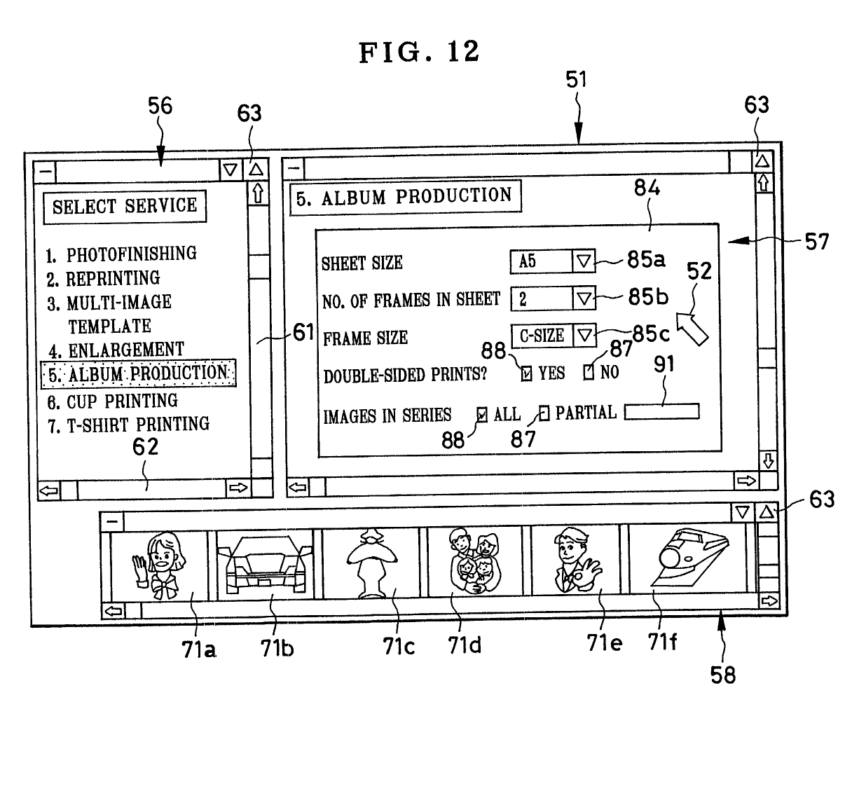

In FIG. 12, a designating menu image 84 of the service item “5. ALBUM PRODUCTION” is illustrated, and indicates various conditions such as a sheet size, the number of frames in one sheet, a frame size, designation of double-sided prints, and selection of images in series. Layout input boxes 85a, 85b and 85c for layout information are indicated beside the indications of respectively the sheet size, the number of frames in one sheet, and the frame size.

Each end of the layout input boxes 85a, 85b and 85c has a list indicating button, which can be clicked to indicate a menu list. The menu list of the layout input box 85a presents information of sheet sizes of A4, A5, B5 and the like. A desired size, for example A5, is designated in the menu list. The size of A5 is indicated in the layout input box 85a. The number of frames in the sheet, the frame size and the like are input in a similar manner.

To designate the double-sided prints, a checking mark 88 is filled in one of checking boxes 87 of YES and NO. When YES is designated, images will be printed on both surface of a single sheet.

To designate all of the images read from the memory card, one of the checking boxes 87 beside the word “ALL” is clicked to fill in the checking mark 88. To designate part of the images read from the memory card, one of the checking boxes 87 beside the word “PARTIAL” is clicked to fill in the checking mark 88. Upon designating “PARTIAL”, an input box 91 for designation information is rendered active. Images are designated from the common item specifying region 58, to indicate the image numbers of the images in the input box 91. The designating operation of the images in the common item specifying region 58 is similar to the other service items of the above.

When all conditions are input, the designating menu image 84 is viewed before depressing the return key. Upon the depression, the ordering information and the cost are indicated. If all the items in the indication is accepted by the customer, he or she depresses the return key again to confirm the order.

When the ordering information is confirmed, an ordering information file is produced. The ordering information file and the image data is sent to the order accepting terminal device 16C. The associate C receives the file and data, and accepts the order. Upon completion of the acceptance, the message of the completion is sent to the order accepting terminal device 16A. The order accepting terminal device 16A indicates the message upon the receipt. At the same time, the file and data and the completion message are written to the HDD 43.

When the service item “7. T-SHIRT PRINTING” is selected, the menu image information is read from the order accepting terminal device 16C, and indicated in the conditioning item setting region 57. A customer places an order by following the guidance in the menu image. The conditions are combined as an ordering information file, which is sent to the order accepting terminal device 16C together with the designated image data, so the order is accepted. When the service item “4. ENLARGEMENT” is selected, the menu image information is read from the order accepting terminal device 16D. A customer places an order by viewing the menu image.

When the associates A-D receive an order, the printing systems 21-24 are operated to produce prints according to the ordering information of the order. When the printing operation is completed, products at the associates B, C and D are sent to the shop of the associate A. Payment or settlement between the associates A-D is effected according to the ordering information.

Accordingly, the customer can receive the product and make payment only at the shop of the associate A even when he or she must pay to, and receive the product from, the associates B, C and D.

In the above embodiment, the order is placed by use of the order accepting terminal device 16A. Of course, the operation is the same if orders are placed by use of the order accepting terminal devices 16B, 16C and 16D.

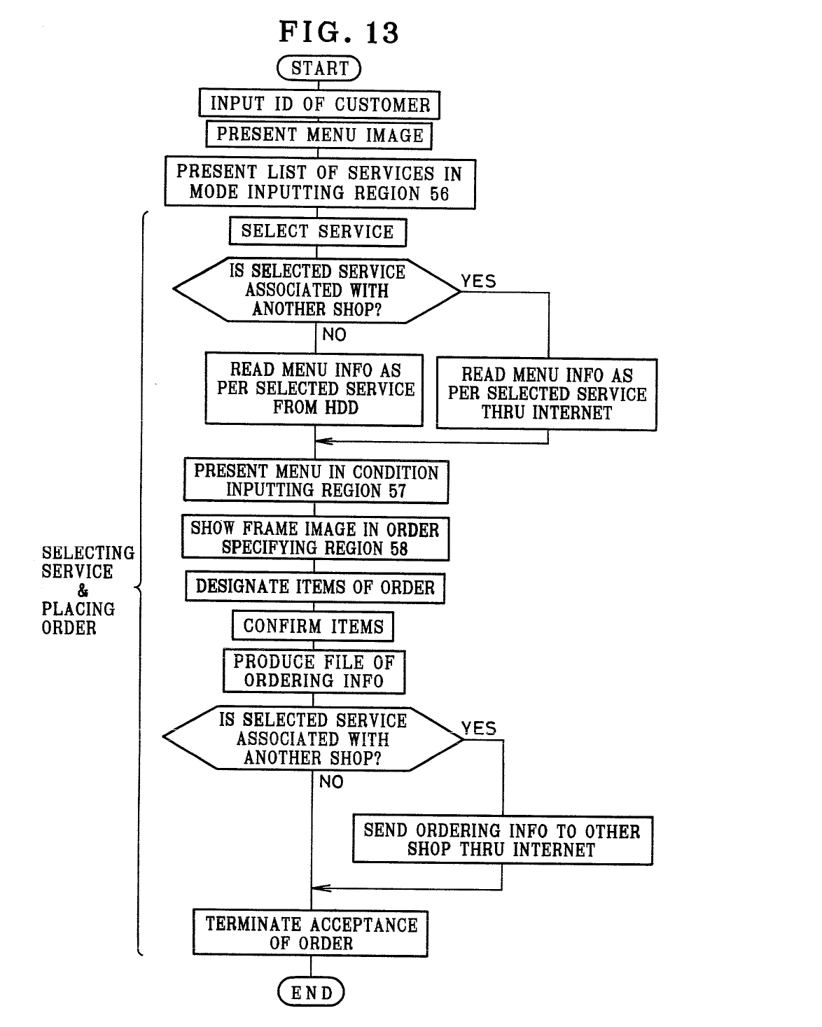

The operation of the present invention is described by referring to FIG. 13. A customer places an order by operating any one of the order accepting terminal devices 16A-16D. At first, his or her customer ID is input, so the display panel 37 indicates the order placing menu image 51. One of the service items is selected in the service selecting region 56. A menu for designating conditions is indicated in the conditioning item setting region 57 according to the selected service item. If the service item is not associated with the shop where the customer operates the terminal device, then menu image information is retrieved through the Internet 17 and indicated. In contrast, if the service item is what is provided by the associate where the customer places an order, then menu image information is read from the HDD 43, and indicated in the display panel 37.

When a service item is selected, images are read from the memory card, and indicated in the common item specifying region 58 in a listed manner. In the menu image in the conditioning item setting region 57, various conditions included in ordering information are designated and input. To select images to be printed, some of the images in the common item specifying region 58 are designated by the same operation irrespective of differences between the service items. The construction of the common item specifying region 58 is effective in simplifying the designating operation, because the images can be designated in the same operation between the plural service items.

When the ordering information is confirmed, then an ordering information file is produced, to complete acceptance of the order. If a different associate is associated with the selected service item, then the ordering information file is transmitted to the different associate, to complete the acceptance. The respective associates, upon accepting an order, produce prints or a product according to the order. In case of the different associate, the prints or product is transferred to the initial associate, so the customer is provided with the prints or product by the initial associate.

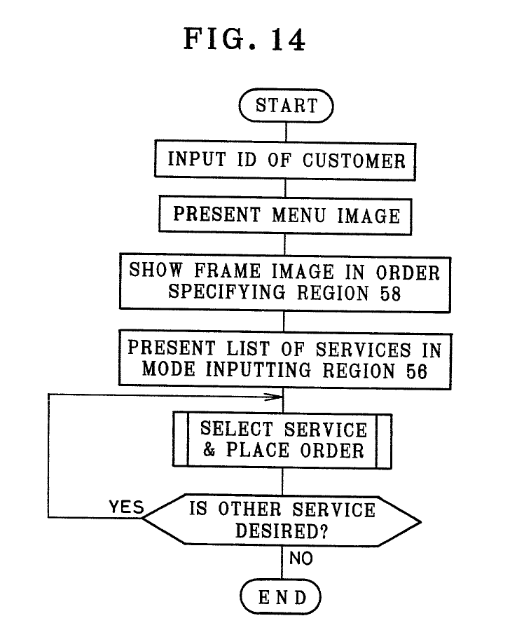

In the above embodiment, images are read from the memory card at the time of selecting a service item. However, images may be read at the time of presenting the order placing menu image 51. A customer may wish to place orders of more than one service item one after another. A flow depicted in FIG. 14 can be used. Images can be read at the first time, but do not need being read at the second time or later. The operation is simplified. Time required for image reading can be short.

Furthermore, plural types of menu image information, which is predetermined by the plural associates, may be registered or stored in any of the order accepting terminal device. In the above embodiment, menu image information is transmitted, retrieved and read from each one different terminal device upon selecting one of the service items. This causes a problem of low speed of indication in the processing. However, the registration of the plural types of menu image information makes it possible to raise the speed of indication in the processing, because no transmission, retrieval or reading of a menu is required.

In the above embodiment, the ordering information and image data is transmitted between the plural associates in a real time manner upon confirming the ordering information. However, the transmission may not be in the real time manner. Ordering information according to two or more orders may be combined and transmitted at one time in a timely manner.

In the above embodiment, the Internet 17 is used. However, the servers may be linked by other communication lines, such as a public telephone network, a specified communication line of the service network and the like. Those examples of the communication lines can be suitably selected in consideration of a cost, confidentiality of data to be treated, or the like.

Furthermore, the servers or the terminal device at the associates may not be interconnected with communication lines. The ordering information can be written to storage medium such as MO, DVD, CD, FD and the like, which may be shipped from one associate to another by use of a mail, private courier and other transporting means.

In the above embodiment, all the order accepting terminal devices 16A-16D are operable to customers directly. However, the service network of the invention may include at least one first terminal device open to customers, and at least one second terminal device not open to customers. To be precise, the first terminal device can operate both to send and to receive ordering information. The second terminal device can operate only to receive ordering information without sending such information.

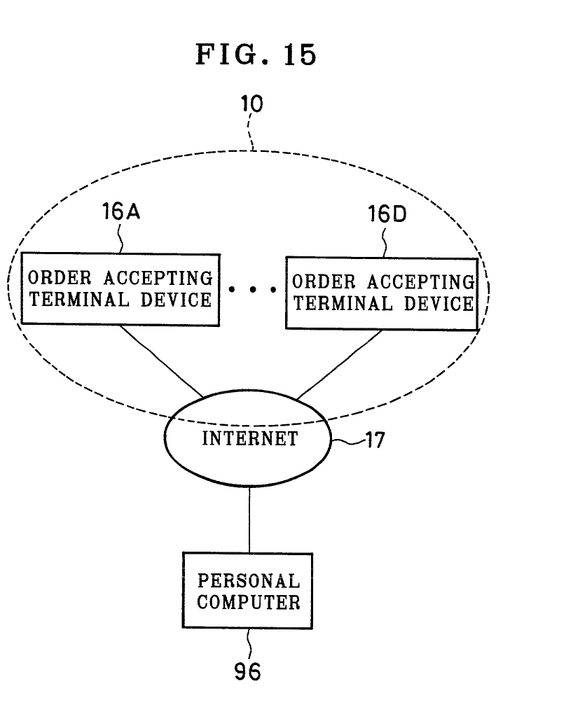

Furthermore, customers do not need to come to a shop with the terminal device. In FIG. 15, an embodiment is illustrated, in which a customer's personal computer 96 or terminal device is operated by him or her, and connected to the order accepting terminal devices 16A-16D of the service network 10 through the Internet 17 for the purpose of placing an order.

To this end, menu image information is stored in a form of a web site in the order accepting terminal devices 16A-16D, which are used as web servers. A virtual mall is constituted in the web by the associates belonging to the service network 10. A customer operates the personal computer 96, starts a web browser installed in the personal computer 96, and designates a URL address assigned to the order accepting terminal device 16A. The personal computer 96 accesses the order accepting terminal device 16A through the Internet 17, and reads a web page of the web site to indicate the menu image by the web browser.

A top page of the web site carries information to guide all the services provided by the printing associates in the service network 10. An ordering button is indicated in the top page with words of “Place an Order of Printing”. A menu image can be read to appear upon clicking the ordering button.

The menu image is constituted by the service selecting region 56, the conditioning item setting region 57 and the common item specifying region 58. The customer designates various items by following the guidance in those regions. After confirming the input items, ordering information and image data designated in the personal computer 96 is sent to the order accepting terminal device 16A. Upon acceptance of the order, a completion message is sent from the order accepting terminal device 16A back to the personal computer 96, and is indicated by the web browser.

In the above embodiments, the plural associates are correlated. However, there can be only a single associate that can provide plural service items. Also, plural shops may be correlated and may be run by the single associate. Order accepting terminal devices may be installed in respectively the shops, and may be interconnected by communication lines to constitute a network.

In the above embodiments, plural terminal devices constitute the network. However, an order accepting apparatus of the present invention may be a single terminal device. Even though there are plural shops and plural service items provided by those, the single terminal device may be used in a state standing alone. Again, the menu image is constituted by the service selecting region 56, the conditioning item setting region 57 and the common item specifying region 58. A customer's operation of inputting items can be simplified.

Furthermore, a commercially available personal computer may be used as an order accepting terminal device. For use with the computer, a program is stored in a storage medium such as CD, the program being constructed to execute steps including a step of indicating the menu image, a step of producing ordering information by viewing the menu image, and a step of sending the ordering information to another order accepting terminal device in the network by a communication line. The software of the program is installed in the personal computer by using the storage medium.

Furthermore, the above-described program may be installed in a personal computer of a customer. This enables him or her to place an order of printing without using a web browser. Also, there is no need of time for downloading menu image information from a web site of each associate in comparison with a construction in which no menu image is included in the program.

In the above embodiments, frame images are printed or recorded. However, the services of the present invention may be to reproduce the images in a specially desired manner, to edit the images, or to process the images. Furthermore, an object to be recorded or otherwise treated may be literal expressions, sound, speech, magnetic data or the like in place of the images.

In the above embodiment, the order is placed to produce prints. However, any product or services may be produced or provided according to the present invention. In those forms of business, the term of product means an article with a certain shape to be sold and bought. The term of service means an object to be traded but having no shape.

In short, the prints, album, cup or T-shirt of the above embodiment may be any type of merchandise which may be ordered, made and sold as a custom-made product.

Also, the service according to the wording in the present invention may be to sell a product without any process of production. For example, tens or hundreds of kinds of products may be previously made, and classified in terms of three or more modes, conditions or other specifics. Three regions in a menu image can be used with advantages according to the invention.

The service network 10 may be constituted by plural associates selling clothes, such as the associates selling underwear and the associates selling clothes other than underwear. For such a case, the common item specifying region 58 is used to designate body sizes of height, bust, waist, hip and the like of a customer. On the other hand, the conditioning item setting region 57 is used to designate colors and a shape of a product. Thus, the number of steps of manually designating the sizes for each service item can be reduced, to simplify the operation. Each of the associates designates the most suitable size according to the size information input by the customer, to provide a product. In the case of the clothes, different sizes are determined by plural manufacturers even if the indications S, M and L for sizes are common between the manufacturers. This being so, the customer does not need to check the relationship between the sizes and the size indications according to each manufacturer.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. An order accepting method comprising steps of:
indicating a menu image in a display panel for inputting ordering information to specify an order placed for a service provided by an associate; and
determining said ordering information in response to an input signal according to said menu image;
wherein said menu image includes plural regions for setting plural items included in said ordering information, said plural regions including:
a service selecting region for selecting one of plural services different from one another;
a common item specifying region for specifying a common item common between said services; and
a conditioning item setting region for setting a conditioning item settable according to said selected service.

2. An order accepting method as defined in claim 1, wherein said plural services are provided by plural associates.

3. An order accepting method as defined in claim 2, wherein said plural services are printing services for printing an image.

4. An order accepting method as defined in claim 3, wherein said ordering information is sent to one of said associates through a communication line, and said one associate is combined with a selected one of said plural services according to said ordering information.

5. An order accepting method as defined in claim 4, wherein said conditioning item setting region is preset individually between said plural associates.

6. An order accepting method as defined in claim 4, wherein said conditioning item includes information of a product type of a product according to said service, layout information of said image in said product, and/or information of an amount and/or cost of said product, and wherein said layout information includes information of a size of said product, disposition of said image, and/or a size of said image.

7. An order accepting method as defined in claim 4, wherein said plural services include at least one of a service of developing photo film and printing said image, a reprinting service of said image, a printing service according to a template layout of plural images, an enlarging printing service of said image, a producing service of a booklet of plural images, a printing service of said image to a sheet, and a printing service of said image to an article.

8. An order accepting apparatus comprising:
a display panel for indicating a menu image for inputting ordering information to specify an order placed for a service provided by an associate; and
an input unit for inputting an input signal according to said menu image;
a controller for determining said ordering information in response to said input signal;
wherein said menu image includes plural regions for setting plural items included in said ordering information, said plural regions including:
a service selecting region for selecting one of plural services different from one another;
a common item specifying region for specifying a common item common between said services; and
a conditioning item setting region for setting a conditioning item settable according to said selected service.

9. An order accepting apparatus as defined in claim 8, wherein said plural services are provided by plural associates.

10. An order accepting apparatus as defined in claim 9, wherein said plural services are printing services for printing an image.

11. An order accepting apparatus as defined in claim 10, further comprising a communication control unit for sending said ordering information to, or receiving said ordering information from, one of said plural associates through a communication line, said one associate being combined with a selected one of said plural services.

12. An order accepting apparatus as defined in claim 11, wherein said conditioning item setting region is preset individually between said plural associates.

13. An order accepting apparatus as defined in claim 11, wherein said conditioning item includes information of a product type of a product according to said service, layout information of said image in said product, and/or information of an amount and/or cost of said product, and wherein said layout information includes information of a size of said product, disposition of said image, and/or a size of said image.

14. An order accepting apparatus as defined in claim 11, wherein said service selecting region and said conditioning item setting region are arranged horizontally to one another.

15. An order accepting apparatus as defined in claim 11, wherein said common item specifying region is disposed under at least one of said service selecting region and said conditioning item setting region.

16. An order accepting apparatus as defined in claim 11, wherein said plural services include at least one of a service of developing photo film and printing said image, a reprinting service of said image, a printing service according to a template layout of plural images, an enlarging printing service of said image, a producing service of a booklet of plural images, a printing service of said image to a sheet, and a printing service of said image to an article.

17. A storage medium for storing an order accepting program, said order accepting program executing a step of indicating a menu image in a display panel for inputting ordering information to specify an order placed for a service provided by an associate, and a step of determining said ordering information in response to an input signal according to said menu image, said storage medium comprising:
said menu image including plural regions for setting plural items included in said ordering information, said plural regions including:
a service selecting region for selecting one of plural services different from one another;
a common item specifying region for specifying a common item common between said services; and
a conditioning item setting region for setting a conditioning item settable according to said selected service.

18. A storage medium as defined in claim 17, wherein said plural services are provided by plural associates.

19. A storage medium as defined in claim 18, wherein said plural services are printing services for printing an image.

20. A storage medium as defined in claim 19, further wherein said order accepting program further executes a step of sending said ordering information to, or receiving said ordering information from, one of said plural associates through a communication line, said one associate being combined with a selected one of said plural services.

21. A storage medium as defined in claim 20, wherein said conditioning item setting region is preset individually between said plural associates.
